(19) United States
(12) Patent Application Publication
(10) Pub. No.: US 2005/0216550 A1
(43) Pub. Date: Sep. 29, 2005

(54) Communication mode and group integration for social networks

(76) Inventors: William G. Paseman, Saratoga, CA (US); Robin C. Chang, San Francisco, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/090,348

(22) Filed: Mar. 24, 2005

Related U.S. Application Data
(60) Provisional application No. 60/557,105, filed on Mar. 26, 2004.

(51) Int. Cl. G06F 15/16

(52) U.S. Cl. 709/202

(57) ABSTRACT

A system and method provide a mechanism for integrating social networks and for integrating voice communication with social networks. This is accomplished by an automatic importation mechanism that unifies data from multiple social networks without user intervention. A process is used that creates a universal identity for a user and a table for cross-referencing all of the user identities in different social networks. In addition, a process allows users linked in one communication mode may communicate in a second communication mode. The system includes software portions for enabling the method.

### RELATED APPLICATIONS

This application claims priority under 35 U.S.C. § 119(e) to U.S. Provisional Patent Application No. 60/557,105, filed on Mar. 26, 2004, entitled “Voice Communication Integration and Group Integration for Social Networks,” by William G. Paseman and Robin C. Chang, the entire contents of which are incorporated herein by reference.

### FIELD OF THE INVENTION

This invention relates generally to integrating modes of communication, and more specifically, to integrating online social networks to each other and to other member networks.

### BACKGROUND

As widespread communication via computer networks develops, the use of online social networks has proliferated. A social network is a set of people, organizations, or other entities connected by a set of social relationships, such as friendship, co-working, or information exchange. When social networks are distributed across space and time, as are those described herein, the networks are enabled by a network of computers including mobile devices, such as the Internet, and the information exchanges take place online. Many such social networks currently are in use, such as Yahoo eGroups, the Linked-In business social network, the Friendster social network, Skype (VOIP), MSN (instant messaging), Verizon (cellular phones), Hotmail (email), evite (email invitations), and the Plaxo contact database. Conventionally, these networks are not integrated with one another in any way, requiring users to maintain duplicate data. However, one of the biggest obstacles to success in social networking platforms is motivating people to use the system and to fill out a profile.

In addition, there are many ways in which people communicate, such as by telephone, email, instant messaging, etc. However, these communication mechanisms usually are not integrated. Voicemail, email, and instant messages often arrive to the user via separate channels, having only a loose association to the people in the forums who originated them and little to no automation.

As a result, if a user of a social network wants to make a call, for example using Internet telephony, to another member of the social network, the user must first manually discover the member's Internet telephony number and separately place a call to the member. Likewise, if the user wishes to send an instant message to the member, the user must first manually discover the member's instant messaging handle and make independent contact. In addition, conventional social networking systems do not allow for inter-network communication.

### SUMMARY OF THE INVENTION

The present invention provides a mechanism for integrating social networks and for integrating various forms of communication among social networks. To provide these functions, in one aspect the present invention includes an automatic importation mechanism that unifies data from multiple social networks without user intervention. The mechanism includes a system and method that creates a universal identity for a user and a table for cross-referencing all of the user identities in different social networks. In addition, the system and method allow for retrieval of the identity and other information stored in the networks without duplicative user input.

The system provides an import helper module that passes on discovered data to a central server, so as to automatically deduce an entire third party social network, including the degrees by which people are separated from one another. This method operates by merging the private directories of each member of the network and does not require an authentication protocol. Thus, the present invention provides a novel method of registration within a network that does not rely on email invitations.

In another aspect, the present invention includes a mechanism for ascertaining available communication modes for a user and his “friends” in various networks. As a result, users linked in one communication mode may communicate in a second communication mode.

Thus, the present invention allows a user of a social network who wants to communicate with, for example make a call or send an instant message, to another member of the same or a different social network to quickly do so without having to manually discover the member's handle and separately make contact. Thus, the present invention provides an add-on mechanism to enable quick, real time, informal voice and other communication between individuals or groups.

The present invention further allows for other applications to utilize and operate upon the aggregate social networking information. This includes, for example, the ability to communicate real-time presence information and perform searching across an aggregated social network.

### BRIEF DESCRIPTION OF THE DRAWINGS

FIG. 1 is a flowchart illustrating a method for unifying online communities according to one embodiment of the present invention.

FIG. 2 is a flowchart illustrating a method of initiating communication in a second mode between parties linked to one another in a first mode.

FIG. 3A is an illustration of the architecture of a system useful for unifying online communities and coordinating communication in additional modes by parties linked to one another in one mode according to one embodiment of the present invention.

FIG. 3B is an illustration of the architecture of a system useful for unifying online communities and coordinating communication in additional modes by parties linked to one another in one mode according to another embodiment of the present invention.

FIG. 4 is a block diagram illustrating user side software for the method of FIGS. 1 and 2 according to one embodiment of the present invention.

FIG. 5 is a block diagram illustrating server side software for the method of FIGS. 1 and 2 according to one embodiment of the present invention.

FIG. 6A is an interaction diagram illustrating an example of a method for integrating social networks according to one embodiment of the present invention.

FIG. 6B is an interaction diagram illustrating a registration process according to one embodiment of the present invention.

FIG. 7 is an interaction diagram illustrating an example of a method for initiating communication in a second mode between parties linked to one another in a first mode according to one embodiment of the present invention.

FIG. 8 is an illustration of a user interface associated with the Friendster social network.

FIGS. 9A and 9B are examples of a secretary user interface according to one embodiment of the present invention.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE EMBODIMENTS

Overview

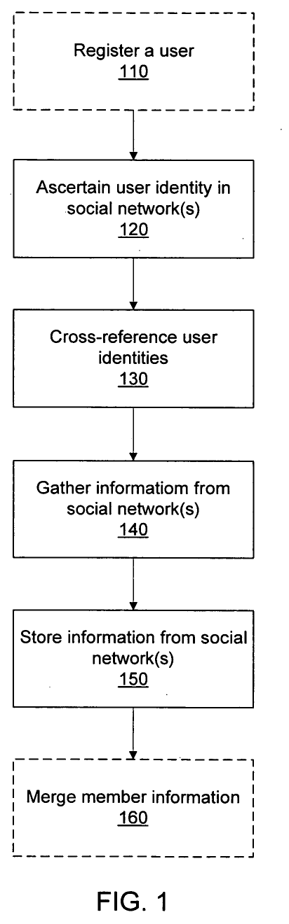

FIG. 1 is a flowchart illustrating a method for unifying online communities according to one embodiment of the present invention. As a preliminary step, a user registers 110 with a system for unifying online communities. The registration may come in many forms, including an Internet download via a browser or a software installation from disk. In one embodiment, the user submits an online registration form via a browser to activate the user's status with the system. In this example, the user is given a universal identity as a result of the registration. The universal identity allows the system to have a single identity so that the user's identity in various social networks can be interconnected, as described below in conjunction with Table 1. Next, the user's identity in one or more online social networks is ascertained 120. In one embodiment, the identities are ascertained when the user logs into the various online social networks using the identities. For example, the user may log into a first social network with a first identity, which the system stores. Then, the user may log into a second social network with a second identity, which the system also stores. Next, the system cross-references 130 the identities ascertained from the social network with the universal identity associated with the user in step 110. This aspect of the invention is beneficial because it allows the system to recognize all of the user's identities in the various social networks as being associated with the user.

In one embodiment, the identity data is stored in a database table. For example, the table may include the user's universal identity, an identifier of the social network to which the user belongs, the user's identity in the social network, and attribute name/value pairs for relevant information in the community, such as name. Using a simple example in which Jonathan Smith, who has a universal identity of X202, is a member of the Friendster social network, where he has an identity of 101, the table would be laid out as follows:

TABLE 1

| Universal ID | SN | SN ID | attrName | value |
|---|---|---|---|---|
| X202 | Friendster | 101 | firstName | ‘Jonathan’ |
| X202 | Friendster | 101 | lastName | ‘Smith’ |

In addition, the system gathers 140 information, or “metadata,” from the various third party social networks, such as that associated with the user within the social network. Metadata is gathered as described above, when the user visits the various social network sites. Gathered metadata may include other information about the user, for example user interests or contact information such as a voice over internet protocol (VOIP) telephone number, information about other members of the social network that the user lists as contacts, as well as data definitions and rule files for the data. In one embodiment, the system gathers data without the need for user interaction in the process, by importing the data from the social network site. In one embodiment, content that was previously entered by the user is extracted from web pages hosting the data using an automatic script, after the user has given the system permission to do so. The script gets the contents of an HTML page, parses it for data, and then writes the data to a database. In this example, the user sets preferences for how much data may be gathered, allowing the system to gather all or a portion of the metadata from the social network. In addition, the user may specify preferences as to how much of the metadata is shared with other members of the social network or other social networks. This aspect of the invention is advantageous because it removes the need for repetitive data entry by the user of the user's information from one network to another and allows the system to automatically deduce an entire social network, including the degrees by which people are separated from one another. The system does so by ascertaining and storing friend-of-friend relationships that define the third party social network.

Then, the gathered metadata is stored 150 by the system in a way that associates the information with the user. In the above example in which the user identity information is stored in table, the gathered metadata is added to the user's table. Using a simple example in which Jonathan Smith's information includes only his VOIP number, obtained from Skype, and his two contacts, 102 and 103, the table would be laid out as follows:

TABLE 2

| Universal ID | SN | SN ID | attrName | value |
|---|---|---|---|---|
| X202 | Friendster | 101 | firstName | ‘Jonathan’ |
| X202 | Friendster | 101 | lastName | ‘Smith’ |
| X202 | Skype | jsmith | VOIPNum | 5551212 |
| X202 | Friendster | 101 | contact | 102 |
| X202 | Friendster | 101 | contact | 103 |

Thus, all the metadata about Jonathan Smith, as stored in the Friendster network, is now available in the table. Importantly, this process occurred without the user having to re-enter the data.

In addition, the system can then merge 160 the metadata of each member of the network without requiring an authentication protocol.

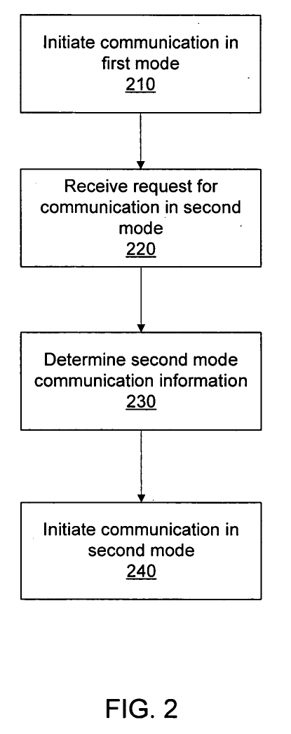

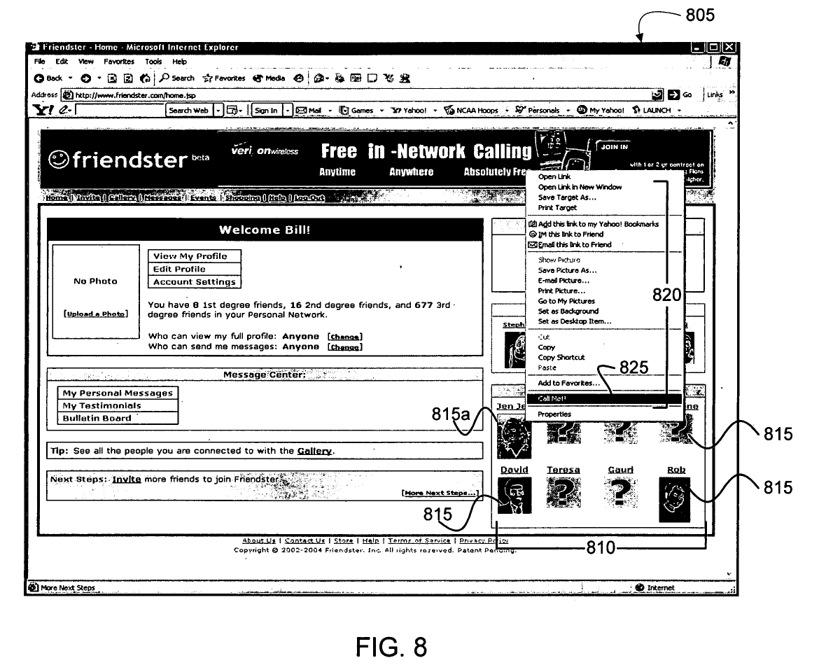

Referring now to FIG. 2, it shows a flowchart illustrating a method of initiating communication in a second communication mode between parties linked to one another in a first communication mode. The communication modes can include any mechanism having members in a network, such as social networks as previously described; the communication modes need not be linked or in communication with one another. This method assumes that registration and metadata gathering has occurred as described in conjunction with FIG. 1. The process begins when the user initiates communication with a friend in a first mode 210. For example, while logged into the system, the user may navigate to a social network website, in which the user and friend are both members. Next, the system receives 220 a request from the user to communicate with the friend in a second mode. The request can come in different forms in various embodiments. For example, preset buttons may exist in a user interface associated with the system for this purpose, or a contextual menu associated with the friend may be used. In one embodiment, the user interface includes a gallery of friends. A gallery is a public directory, viewable to members of the social network within n degrees of separation of the user. FIG. 8 is an illustration of a user interface 805 of the Friendster social network, for which the gallery 810 is displayed to the right side of the user interface 805. The gallery 810 displays icons 815 associated with various friends. In this embodiment, right clicking on a friend, such as Jen 815a activates a contextual menu 820. In addition, the second mode may take many forms, for example instant messaging, internet telephony, email, short message service (SMS) text messaging, standard telephony, or the like. In the example shown in FIG. 8, an internet telephone option, “Call Me” 825, is displayed in the contextual menu 820. In addition, the request must have some identifying information with respect to the friend the user wants to contact. For example, this information may include the identity associated with the friend in a social network. In one embodiment, the identity information may come from a “contact” attribute in the user's table. In the embodiment shown in FIG. 8, each friend has a name next to his or her picture.

Next, the system determines 230 communication information for the second mode. For example, if the second mode is instant messaging, the communication information may be an instant messaging screen name; if the second mode is internet telephony, the communication information may be an internet telephone number. However, because the request includes no information about the second mode communication information, the system uses the user table to find it. For example, the system queries a table associated with the user in which the instant messaging screen names or internet telephone numbers are listed. For example, Jonathan Smith requests to call Jane Doe, identity 107 in the Friendster network, on her VOIP number. By consulting the user table, the system ascertains that Friendster identity 107 is universal identity X205, associated with VOIP number 5551213. Using this information, the system initiates 240 communication in the second mode, for example by initiating the internet telephone call. Thus, even if Jonathan does not know Jane's VOIP number he can call her, so long as Jane lists Jonathan as a contact and has a VOIP number registered with the system.

System Architecture

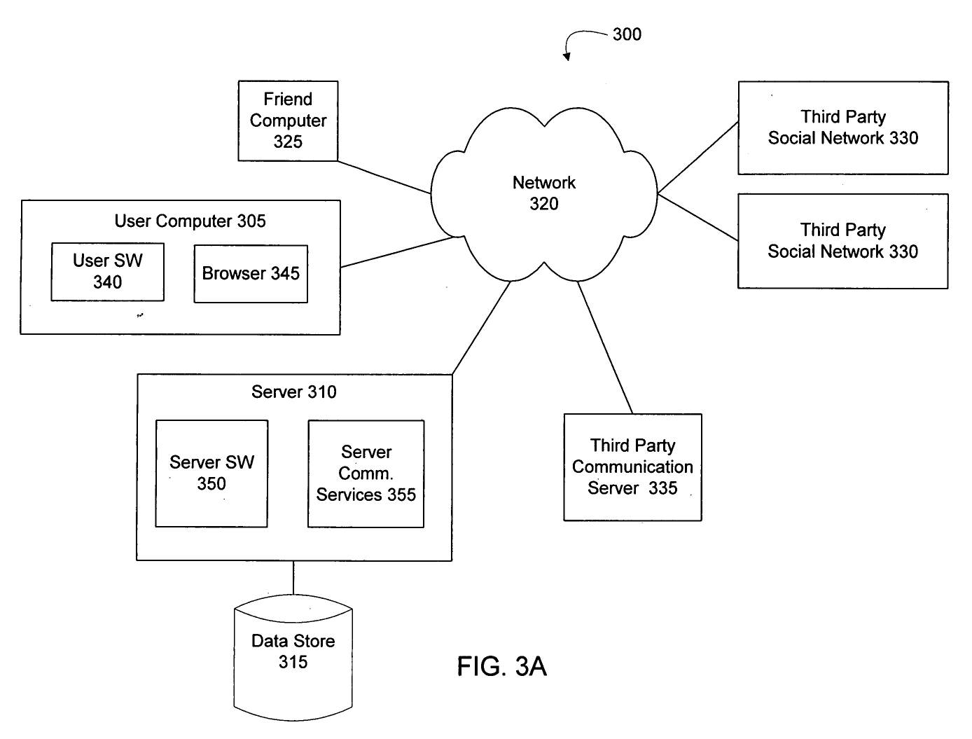

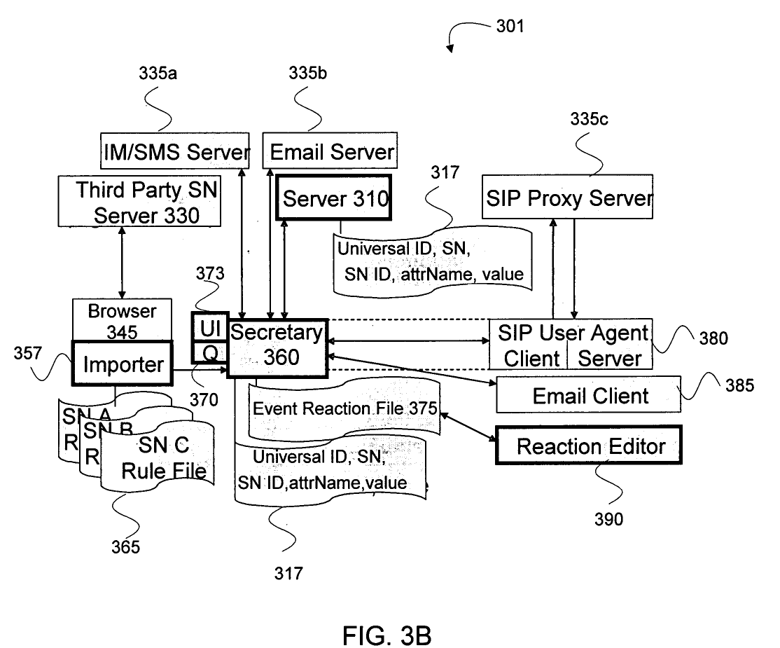

Referring now to FIG. 3A, it shows an illustration of the architecture of a system 300 useful for unifying online communities and coordinating communication in additional modes by parties linked to one another in one mode according to one embodiment of the present invention. The basic components of the system 300 include a user computer 305 and a server 310 with a data store 315 connected via a network 320. The network 320 is a grouping of computers connected by communications facilities to share information, such as the Internet.

The user computer 305 is of conventional design, and includes a processor, an addressable memory, and other conventional features (not illustrated) such as a display, a local hard disk, input/output ports, and a network interface. The network interface and a network communication protocol provide access to the network 320 and other computers, such as server 310, along with access to the Internet, via a TCP/IP type connection, or to other network embodiments, such as a WAN, LAN, MAN or the like. In one embodiment the user computer 305 may be implemented on an Intel-based computer operating under Microsoft Windows XP, Windows 2000, or Windows NT operating system, or a SPARC-based computer operating under UNIX, or any other equivalent devices.

The server 310 may be of conventional design, and can include a standard processor, a computer-readable memory, and a network interface. The server 310 provides HTTP-based services such as serving static and dynamic HTML pages, XML data, and/or multimedia information, and acts to unify information from multiple communities in a standard format. The network interface and a network communication protocol provide access to the network 320 and other computers, such as user computer 305, along with access to the Internet, via a TCP/IP type connection, or to other network embodiments, such as a WAN, LAN, MAN or the like. The server 310, depicted as a single computer system, may be implemented as a network of computer processors. In one embodiment, the server 310 is a J2EE compliant server.

The data store 315 is communicatively coupled to the server 310. The data store 315 may be a conventional database accessible by the server 310 through a conventional communications interface. The data store 315 is configured for storing information relating to various aspects of server 310 execution, for example storage of data received over the network 320. The server 310 accesses and queries the data store 315 to retrieve data records. In addition, the data store 315 maintains registration information for users, third party social network information, referred to as “metadata,” imported from the third party social networks, and metadata definitions. In one embodiment, the data store 315 is implemented via a mySQL database. Further, the data store 315 may include functionality for supporting queries for searching a user's aggregated friend network.

In addition, the system 300 may include third party components, such as one or more friend computers 325, one or more third party social networks 330, and/or one or more third party communication servers 335.

The friend computer 325, when present, is the computer of a friend of the user associated with one or more social networks to which the user belongs. The friend computer 325 is of conventional design, similar in structure and function to the user computer 305, and it connected to the network 320.

The third party social network 330 is a forum to which people, such as the users of user computer 305 and friend computer 325 belong. Through these third party social networks 330, users can contact existing friends and business acquaintances and make new ones. Examples of third party social networks 330 include Yahoo eGroups, the Linked-In business social network, and the Friendster social network. The third party communication server 335 may be of conventional design, and can include a standard processor, a computer-readable memory, and a network interface for connecting to the network 320. The third party communication servers 335 are used for various forms of communication between users. Examples of third party communication servers 335 are servers for services with a directory of users, such as email servers, voice over internet protocol (VOIP) servers, egroup servers, email invitation servers, calendar servers, contact database servers, SMS servers, and instant messaging servers. One skilled in the art will recognize that other types of servers can also be used.

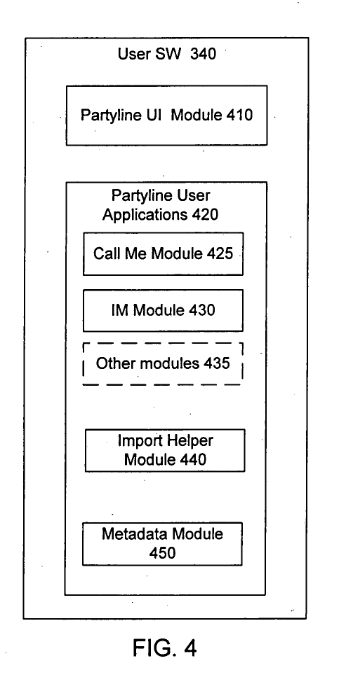

In one embodiment, the user computer 305 further includes software 340 and a browser 345. The software 340 includes a number of executable code portions and data files for using the system 300 according to one embodiment of the present invention, as described further in conjunction with FIG. 4. These include code for creating and supporting the software 340 functionality. The software 340 may be provided to the user computer 305 on a computer readable media, such as a CD-ROM, diskette, or by electronic communication over the network 320 from the server 310 or other distributors of software, for installation and execution thereon. The browser 345 is a client software program used for searching and viewing various kinds of Internet resources such as information on a web site, such as Internet Explorer or Netscape.

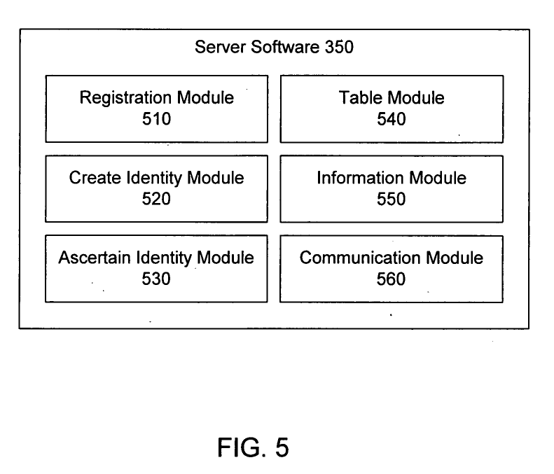

In one embodiment, the server 310 further includes software 350 and a server communications services component 355. The software 350 includes a number of executable code portions and data files for unifying online communities and coordinating communication in additional modes by parties linked to one another in one mode according to one embodiment of the present invention, as described further in conjunction with FIG. 5. These include code for creating and supporting the software 350 functionality.

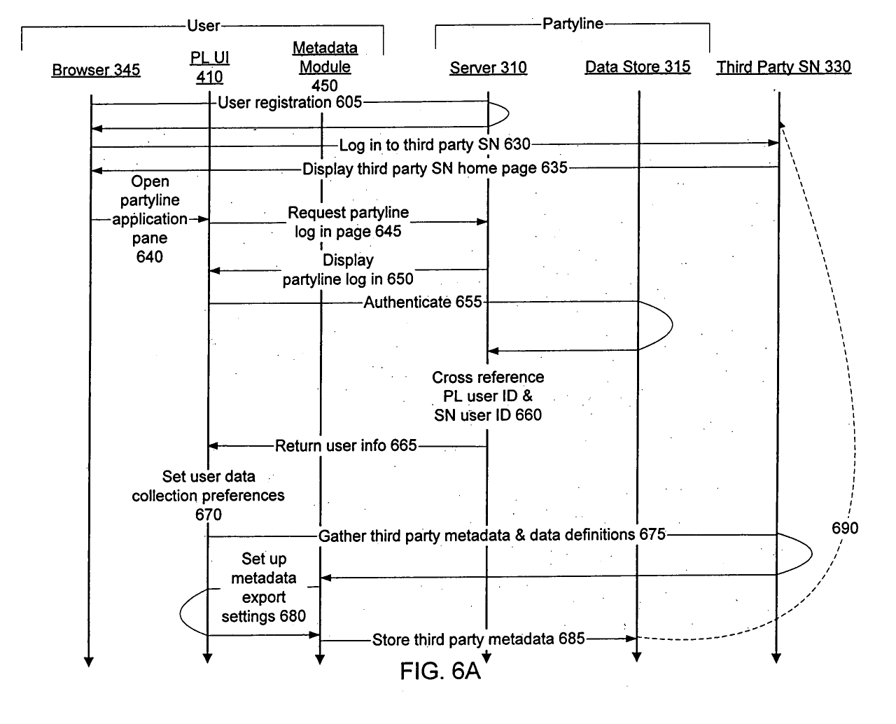

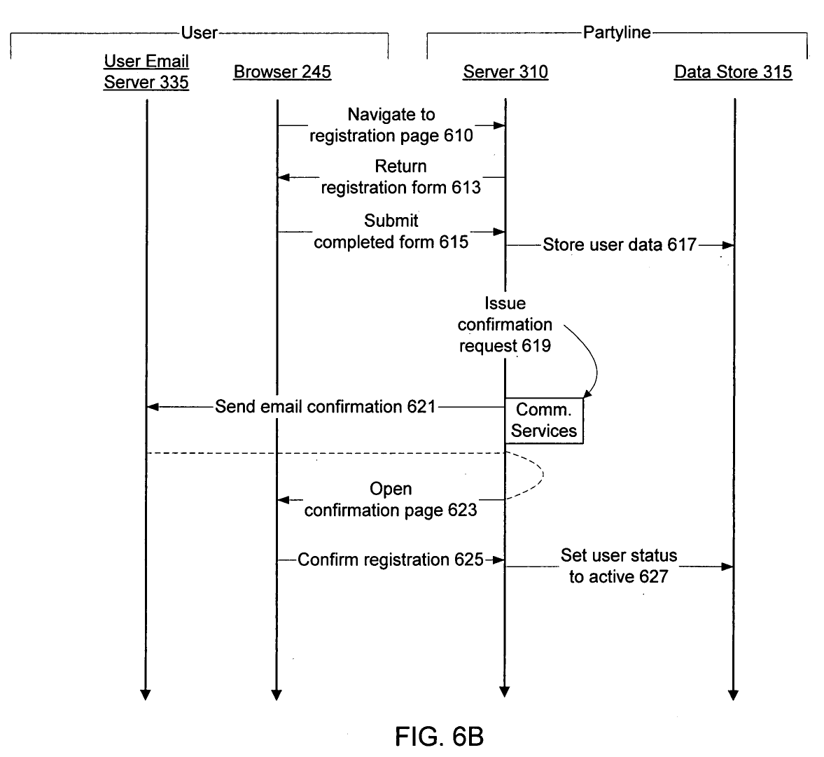

The server communications services component 355 executes logic for providing support for various communication protocols. For example, the server communications services component 355 enables access with the third party communication server 335 to provide access to email, instant messaging, and VOIP telephony. During the registration process described below in conjunction with the embodiment described in conjunction with FIG. 6B, the server communications services component 355 sends an email confirmation to the user's email server.

Referring now to FIG. 3B, it shows an illustration of the architecture of a system 301 useful for unifying online communities and coordinating communication in additional modes by parties linked to one another in one mode according to another embodiment of the present invention.

The system 301 includes some aspects that are similar to the system 300 of FIG. 3A. For example, the system 301 includes a server 310, a third party social network server 330, three third party communication servers 335, and a browser 345.

The server 310 is equivalent to the server 310 described in FIG. 3A. Correspondingly, the server 310 can establish and access a table 317 filled with user metadata, such as Tables 1 and 2.

The third party social network (“SN”) server 330 is equivalent to that of FIG. 3A, such as that for Yahoo eGroups, Plaxo or Friendster.

The third party communication servers 335 include an IM/SMS Server 335a, an email server 335b, and a voice/SIP server 335c. The IM/SMS Server 335a is a third party instant messaging server such as that used for America Online IM or Yahoo IM. The email server 335b is a third party email server accessible via POP/SMTP or similar protocol. In one embodiment, the a voice/SIP server 335c is an interface to any voice service, such as Skype. In another embodiment, voice/SIP server 335c is a standard SIP proxy server used as an element of a VOIP telephone system.

As in FIG. 3A, the browser 345 is a standard browser such as Internet Explorer.

In addition, the system 301 includes additional components and files. The components include an importer 357, a secretary 360, a queue 370, a user interface 373, a voice/SIP user agent 380, an email client 385, and a reaction editor 390. The files include rules files 365 for several social networks and an event reaction file 375.

In one embodiment, the importer 357 is a plug-in to the browser 345 that detects when the browser 345 has entered a third party social network 330. In other embodiments, the importer 357 could be implemented in other ways, for example as a standalone tool or an extension in the operating system. In some respects, the importer 357 performs functions similar to the partyline user interface 410 described in conjunction with FIG. 4. After obtaining permission from the user, the importer 357 imports user-owned data from the downloaded page to a secretary 360 using the instructions in rule files 365 associated with the social networks 330. The data is imported according to user preferences. In addition, the importer 357 imports call information from the secretary 360 to display in a browser popup.

In one embodiment, a secretary 360 acts as an agent for the user. The secretary 360 serves to enqueue events sent from the various servers and importer 355 according to a priority queue (“Q”) 370. In addition, the secretary 360 dequeues the events in priority order and reacts to events by performing the operations described in an event reaction file 375. The event reaction file 375 is described in greater detail below.

In one embodiment, the secretary 360 caches metadata imported from the importer 335 before passing it to the server 310, information stored in the server 310 before a user interface (“UI”) 373 uses the information, and information communicated from an SIP user agent 380. The secretary 360 also provides real-time user feedback via the user interface 373. In this example, the UI 373 is implemented via Flash such that it may play ring tones, runs animations, and perform other Flash-enabled functions.

The event reaction file 375 is an XML file. In one embodiment, a snippet, or portion, of the event reaction file 375 alerts the user when a user, in this example, a partyline.biz user with phone number sip:1212555 comes online. This mechanism also can be used to counter spam, or if the secretary 360 is used as the primary agent for instant messaging, to counter instant messaging spam, known as “spim.”

Example event reaction file 375:

```
<?xml version=1.0 encoding=UTF-8?>
<!DOCTYPE EVENT-REACTION-FILE PUBLIC -
//partyline.biz//CommBOM-DTD//EN dtd/EVENT-REATION.dtd>
<Partyline-Root Schema-Version=20031017>
<Call name=DefaultCall priority=1>
<notification event=presence
                address=sip:1212555@partyline.biz>
                <alert message= 1212555 is online.>
        <notification/>
</Call>
```

The user uses a reaction editor 390 to author content for this event reaction file 375. The reaction editor 390 can be any XML-enabled editor, or a forms-driven panel.

The voice/SIP user agent 380 may be a voice service user agent, e.g., Skype, as well as an SIP user agent. The voice/SIP user agent 380 records Call-IDs and to whom the user's call is connected. In one embodiment, user agent call information is transient and not sent to the server 310.

The email client 385 is a messaging and collaboration client, for example Microsoft Outlook. The email client 385 is a source of community records that are transmitted to the server 310.

One skilled in the art will recognize that the system architecture illustrated in FIGS. 3A and 3B are merely exemplary, and that the invention may be practiced and implemented using many other architectures and environments.

Software Architecture

Referring now to FIG. 4, it shows a block diagram illustrating user side software for the method of FIGS. 1 and 2 according to one embodiment of the present invention. The software 340 includes a number of executable code portions and data files, including a partyline user interface module 410 and partyline user applications 420.

The partyline user interface module 410 executes logic for displaying a user interface and facilitating interaction between the user, via the user interface, the partyline user applications 420, and the partyline server 310. In one embodiment, partyline user interface module 410 executes logic for logging a user into a partyline server 310, setting user data collection preferences, and gathering third party metadata and data definitions. In addition, in this example the partyline user interface module 410 executes logic for requesting communication in a second mode with people linked with the user in a first mode, for example, to use VOIP telephony to call someone the user is linked to in the online social network. In various embodiments, the partyline user interface module 410 can be implemented as an extension to the browser 345 or as a standalone application. In the embodiments in which it is an extension to the browser 435, it is presented as a customized button in the toolbar area of the browser 345, allowing the user one-click access to the partyline user interface.

The partyline user applications 420 are helper applications that execute logic for facilitating communication and metadata transfer between entities. In one embodiment, the partyline user applications 420 are downloaded from the server 310. The partyline user applications 420 include communications modules 425-435, such as a Call Me module 425, an instant messaging (IM) module 430, and other modules 435, as well as a metadata module 450. The communication modules 425-435 receive commands for, and invoke, connections between communication modes and social network services.

The Call Me module 425 executes logic for allowing a system user to call a social network member to whom the user is linked. In one embodiment, the Call Me module 425 executes logic for determining identification formation for a friend of the user, sending the user and friend identification information to the server 310, and beginning a VOIP session to initiate the call. The Call Me module 425 also may execute logic for implementing a session initiation protocol (SIP) client.

The IM module 430 executes logic for allowing a system user to send and receive instant messages to and from a social network member to whom the user is linked. Likewise, the other modules 435 execute logic for a system user to communicate in other communication modes with a social network member to whom the user is linked in a first communication mode.

The import helper module 440 executes logic for identifying the user on the third party social network site. In one embodiment, the import helper module 440 executes logic for importing metadata the user has entered in the third party social network site, once the user has given the system permission to import. The import helper module 440 passes on the metadata to the server 310, so as to automatically deduce an entire social network, including the degrees by which people are separated from one another. The import helper module 440 does so by ascertaining friend-of-friend relationships that define the third party social network. In addition, the user may specify preferences as to how much of the metadata from the third party network is shared with other members of the various social networks.

The metadata module 450 executes logic for facilitating receipt and storage of metadata from third party social networks. In one embodiment, the metadata module 450 executes logic for receiving third party metadata and data definitions, setting up metadata import settings, and storing third party metadata to the data store, e.g., 315 of FIG. 3A.

The above software portions 410-450 need not be discrete software modules. The configuration shown is merely an example; other configurations are anticipated by and within the scope of the present invention.

Referring now to FIG. 5, it shows a block diagram illustrating server side software for the method of FIGS. 1 and 2 according to one embodiment of the present invention. The software 350 includes a number of executable code portions and data files, including a registration module 510, a create identity module 520, an ascertain identity module 530, a table module 540, an information module 550, and a communication module 560.

The registration module 510 executes logic for registering a user with the system 300. In one embodiment, the registration module 510 accepts online registration forms to activate the user's status.

The create identity module 520 executes logic for establishing a universal identity for a user. In one embodiment, the universal identity is provided to the user as a result of registration.

The ascertain identity module 530 executes logic for ascertaining a user's identity and other user metadata in online social networks. In addition, the ascertain identity module 530 also ascertains friend-of-friend relationships that define the third party social network. In one embodiment, this metadata is obtained by, upon permission from the user, importing data stored in the online social network as entered by the user.

The table module 540 executes logic for creating a table associated with a user. In one embodiment, the table includes the user's identities in various social networks, which are cross-referenced with the user's universal identity, and information about one or more other members linked with the user in the social networks, for example friend-of-friend relationship data. The information module 550 executes logic for ascertaining the identities of members linked with the user in the social networks.

The communication module 560 executes logic for facilitating communication between users in multiple communication modes. In one embodiment, the communication module 560 executes logic for receiving commands for communication in an additional mode, wherein the command includes incomplete communication information for one or more users. In one example, the communication module 560 executes logic to determine whether a VOIP connection can be made, and if so, passes the VOIP phone numbers to the partyline user interface.

The above software portions 510-560 need not be discrete software modules. The configuration shown is merely an example; other configurations are anticipated by and within the scope of the present invention.

Examples

FIG. 6A is an interaction diagram illustrating an example of a method for integrating social networks according to one embodiment of the present invention.

The process begins when a user, via a browser 345, registers 605 with the partyline application software 420. Referring now to FIG. 6B, there is shown an interaction diagram illustrating a registration process according to one embodiment of the present invention. First, the user, using a browser 345, navigates 610 to the partyline registration page. The partyline server returns 613 a registration form. The user submits 615 the completed registration form via the browser 345. The server 310 then forwards 617 the user data from the completed form to the data store 315, creating a table for the user. In addition, the server 310 issues 619 a confirmation request. The partyline communications services 355 aspect of the server 310 then sends 621 an email confirmation per the request to the user's email server. From the email, the user follows a link that causes the server 310 to open 623 a confirmation page in the browser 345. Through the browser 345, the user confirms 625 the registration to the server 310. The server 310 forwards the confirmation to set 627 the user status to active in the data store 315.

Returning to FIG. 6A, after registration 605, the user logs in 630 to a third party social network 330 via a browser 345. The third party causes a home page to display 635 on the browser 345. Then, via the browser 345, the user opens 640 the partyline application pane. In one embodiment, the pane is opened using a customized button in the toolbar area of the browser 345. Once the pane is opened, a request 645 for the partyline log in page is triggered by the partyline user interface 410. In response, the server 310 causes the partyline log in to display 650. The user, via the partyline user interface 410, authenticates 655 by logging in, which the server 310 verifies using the information stored, for example in a table associated with the user, in the data store 315. In one embodiment, this process involves the user of an import helper application 440 on the user side. In addition, the server 310 creates 660 a cross-reference between the partyline (universal) user identification and the social network identification for the user. Then, the server 310 returns 665 the user information to the partyline user interface 410. As a result of the cross-reference, users revisiting the third party social network at a later date do not need to log in (645, 650) to the partyline user interface 410 again.

Next, the partyline user interface 410 provides options to allow the user to set 670 preferences for collection of data from the third party social network 330. For example, the user can choose to import all of the metadata stored with the third party social network or just a subset of the metadata. In addition, the user can choose how much of the data is shared with friends in this and other third party social networks. Per these preferences, the partyline user interface 410 directs the server 310 to gather 675 the third party social network information, referred to as “metadata,” as well as data definitions, updates of previous data and any rule file associated with the data import. In one embodiment, the data is gathered via importing the metadata contained in the social network as entered by the user, without user interaction, upon permission from the user to do so. The data definitions allow the import helper module 440 to import metadata from the third party social network sites in a template-like fashion. The metadata is returned to the application associated with the user interface, which applies 680 the user preferences to the data from the user interface and stores 685 the third party metadata to the data store 315. The data is added to the user table in the data store 315. This process repeats 690 for each third party social network that the user logs into.

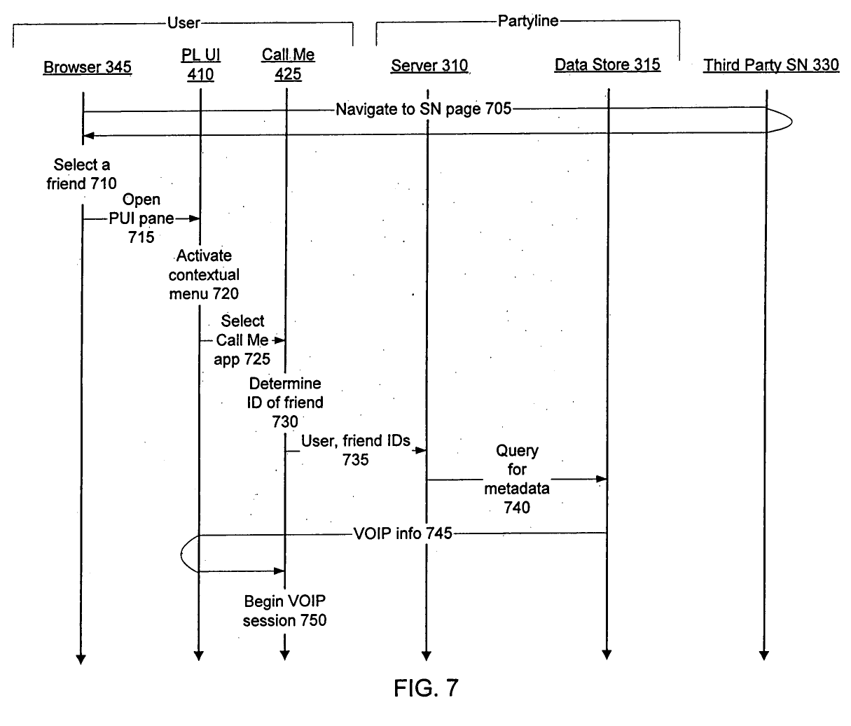

FIG. 7 is an interaction diagram illustrating an example of a method for initiating communication in a second mode between parties linked to one another in a first mode according to one embodiment of the present invention. The process begins by the user navigating 705 to a third party social network site via a browser 345, loading the site for the user. Next, the user selects 710 a “friend” from the social network using the browser 345. In one embodiment, the user selects the friend by clicking on a picture associated with the friend. In addition, the user opens 710 the partyline user interface 410. In one embodiment, the pane is a small window that displays simultaneous with the current window, for example to the left of the screen similar to the way a “history” pane would display. In one embodiment, the partyline user interface pane appears automatically. From the pane, the user activates 720 a contextual menu, for example by right clicking over the picture of the friend. In this embodiment, one of the contextual menu options is a “Call Me” application associated with the partyline program. Call Me is a program that allows the user and the friend, connected only via the social network, to connect via telephone, for example using Skype internet telephony. Next, the user selects 725 the Call Me application from the menu, activating the application. The Call Me application 425 then determines 730 the identity of the friend the user wants to call. For example, the identity of the user's friend may be displayed on the screen next to the friend's picture. The import helper module 440 may help identify the identities by inspecting the currently displayed web page and/or obtaining the active session cookie for the third party social network and using the cookie to gather supplementary web information in the background. In one embodiment, the system checks a user table to verify that the user and the friend list each other as contacts.

The user and friend identities are then forwarded 735 to the server 310 for processing the request. A corresponding Call Me application on the server 310 side queries 740 the data store 315 for metadata associated with the user and friend identities. Based on the query, the data store 315 returns 745 VOIP information for the user and friend to the user-side Call Me application 425 via the partyline interface 410. From the Call Me application 425, the user begins 750 a VOIP session, for example using SIP.

User Scenario: Basic Social Networking Call Application

This scenario creates a peer-to-peer connection between two terminals with no event feedback. This scenario assumes no secretary 360 functionality on the user computer 305.

Initially, a common friend sends email invitations to both He and She to join a third party social network 330, for example Friendster. Next, He accepts the invitation and enters his email address and a Skype VOIP phone number of 4761111 in the third party social network 330. Then, She accepts and enters her email address and a Skype VOIP phone number of 5551212 in the third party social network 330. As a result of these actions, both He and She list each other in a directory entry in their respective galleries, such as the gallery 810 of FIG. 8, in the third party social network 330. Each gallery is a public directory in the third party social network 330, viewable to everyone within n degrees of separation in the network 330.

After the above directory entries are established, He and She can view each other in their respective gallery views. An example of He's gallery view is shown below.

| | | | | |
|---|---|---|---|---|
| Romy connect | Grace connect | Marni connect | Michelle | Autumn |
| <picture> | <picture> | <picture> | connect | connect |
| | | | <picture> | <picture> |
| Princess | Myra connect | Alison connect | Abigail connect | Ester connect |
| connect | <picture> | <picture> | <picture> | <picture> |
| <picture> | | | | |
| She connect | RiceBud connect | Laurie | Maggie connect | Shira connect |
| <picture> | <picture> | <picture> | <picture> | <picture> |

### He's Gallery 1

To place a call, He goes to the gallery, and presses “connect” on She's picture. If She is off-line, or the line is busy, the call fails. In this scenario, call status is not reflected in the Gallery screen. The “connect” link allows He to place a call to anyone listed in the gallery (other than Laurie) with one click. Laurie, knowing of He's infatuation with She, has made her number unlisted to He, and thus does not display a “connect” link to He.

This scenario is implemented using two major components: a central social networking server (such as provided in Friendster) and a peer-to-peer VOIP telephone service (such as Skype). No events are generated in this scenario.

User Scenario: Basic Secretary Enabled Call Application

The system 300 creates a peer-to-peer connection between two terminals with no event feedback. This is very scalable because the system 300 need only be responsible for call initiation, and need not be responsible for signaling (voice transport), session management (controlling the attributes of an end to end call), or ensuring that a connection was made.

Initially, a common friend sends email invitations to both He and She to join a third party social network 330, for example Friendster. Next, He accepts the invitation and enters his email address. He is running a secretary, e.g., 360 of FIG. 3B, connected to a server, e.g., 310 of FIG. 3A, which knows He's VOIP phone number of 4761111. In one embodiment, He has previously registered with Partyline via the process described in FIGS. 6A and 6B. Then, She accepts and enters her email address. She also is running a secretary connected to a server that knows her VOIP phone number of 5551212. As a result of these actions, both He and She list each other in a directory entry in their respective galleries.

During the course of social network traversal, He and She each register their respective Friendster IDs and VOIP phone numbers in the server, e.g., 310, as described above in conjunction with FIGS. 6A and 6B and Tables 1 and 2.

After the above directory entries are established, He and She can view each other in their respective gallery views. An example of He's gallery view is shown below.

| | | | | |
|---|---|---|---|---|
| Romy connect | Grace connect | Marni connect | Michelle | Autumn |
| <picture> | <picture> | <picture> | connect | connect |
| | | | <picture> | <picture> |
| Princess | Myra connect | Alison connect | Abigail connect | Ester connect |
| connect | <picture> | <picture> | <picture> | <picture> |
| <picture> | | | | |
| She connect | RiceBud connect | Laurie | Maggie connect | Shira connect |
| <picture> | <picture> | <picture> | <picture> | <picture> |

### He's Gallery 2

Note the “connect” link as described above in conjunction with He's Gallery 1. If the social network provider 330 implements this functionality, this link can be provided directly. If this is an add-on, “connect” signifies the contents of a drop-down menu, such as described in conjunction with FIG. 8, provided by the system 300 when the user clicks on the indicated cell. This allows He to place a call to anyone listed in the gallery with one click (other than Laurie). As above, Laurie has made her number unlisted to He. In this embodiment, all users can apply access restrictions to, for example, show themselves as unlisted to selected friends.

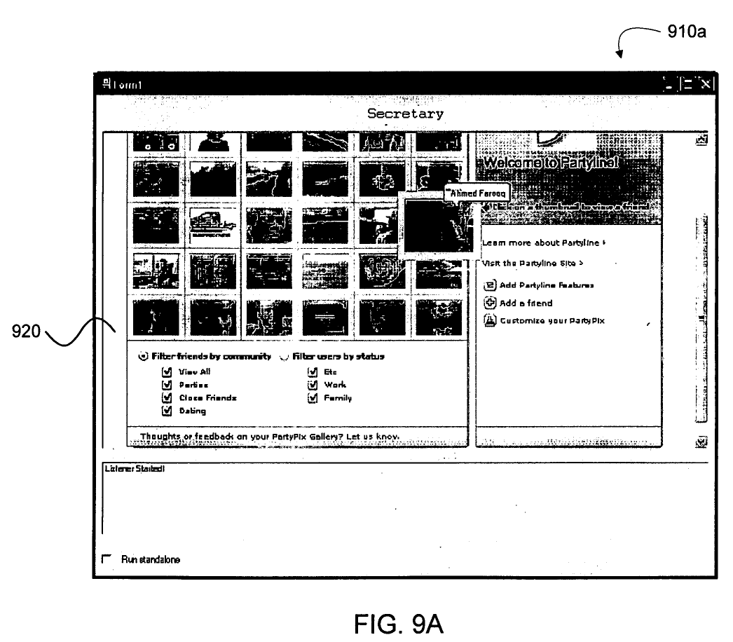

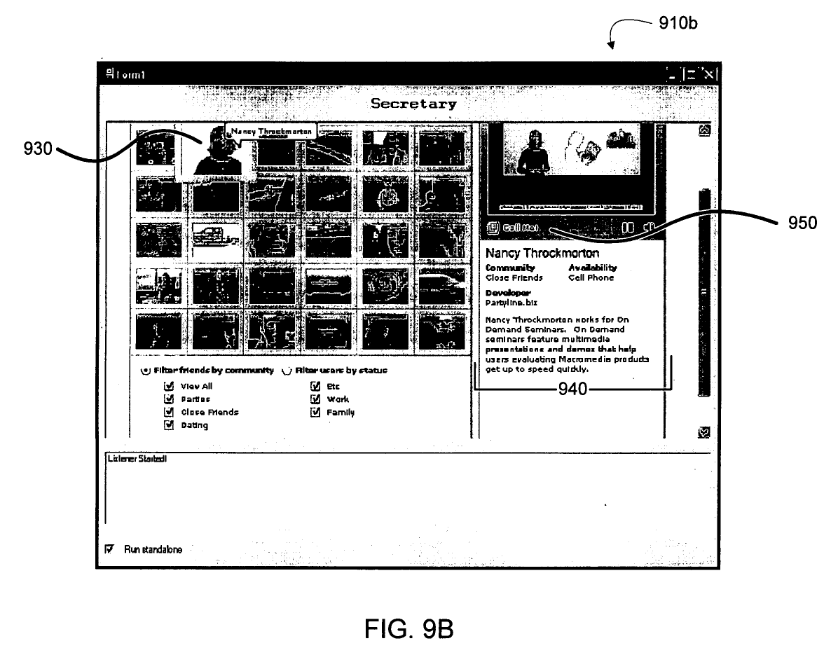

To place a call, He goes to the gallery, and presses “connect” on She's picture. If She is off-line, or the line is busy, the call fails. In this scenario, call status is not reflected in the gallery screen. FIG. 9A is an example of a secretary user interface 910a showing a gallery screen 920. The gallery 920 is populated by selecting the filter options at the bottom of the interface 910a. In one embodiment, the interface 910a uses a Flash Interface Component. Next, the user can select a friend to call.

FIG. 9B shows the user interface 910b once the user has passed his mouse over Nancy Throckmorton's image 930. Flash then raises a bubble, expands and animates Nancy's image 930. Clicking the image 930 provides a detail view 940 on the right hand side of the screen. We see that Nancy is available by cellular phone, and can be called via the call me button 950. This functionality is similar to the “Call Me” option 825 discussed in conjunction with FIG. 8.

In addition, existing social networking services can be identified and a call menu added to tie into the secretary. The interface for this method is shown in FIG. 8.

User Scenario: Extended Secretary Enabled Call Application with Events

This scenario is implemented using code running at an origination site, such as a user computer 305 and at a destination site, such as a friend computer 325, as well as on a server, e.g., 310. The code running on the origination site and destination site is implemented, for example, using techniques similar to currently available Instant Messenger products such as Yahoo Instant Messenger, and also provides but does Call (Voice Telephony) control in addition to Message (Text Message) Control. For purposes of the following description, this code is referred to below as He's secretary and She's secretary.

Initially, a common friend sends email invitations to both He and She to join a third party social network 330, for example Friendster. Next, He accepts the invitation and enters his email address. He is running a secretary, connected to a server, which knows He's VOIP phone number of 4761111. Then, She accepts and enters her email address. She also is running a secretary connected to a server that knows her VOIP phone number of 5551212. As a result of these actions, both He and She list each other in a directory entry in their respective galleries.

During the course of social network traversal, He and She each register their respective Friendster IDs and VOIP phone numbers in the server, e.g., 310, as described above in conjunction with FIGS. 6A and 6B and Tables 1 and 2.

After the above directory entries are established, He and She can view each other in their respective gallery views. Next, He invites She to be his friend and She accepts. He now has her picture in an entry in his My Friends screen (not shown). In one embodiment, the My Friends screen is a private directory, viewable only to He. It is a strict subset of the gallery view described above.

Next, he wants to define what the secretary should do when he receives a call from the friend listed in the My Friends screen. He goes from his My Friends screen to his Secretary's Edit Friends Screen, shown below. The Edit Friends screen allows him to define what the software should do when he receives a call from the friend listed. He changes from the Edit Friends default view, shown below, to the Edit Friends secretary view, also shown below.

| | |
|---|---|
| She [Delete Friend] | RiceBud [Delete Friend] |
| <picture> | <picture> |

### Edit Friends Default View

| She [Delete Friend] | | RiceBud [Delete Friend] | |
|---|---|---|---|
| <picture> | | <picture> | |
| If the | | If the | |
| Phone | Then your Secretary | Phone | Then your Secretary |
| does this . . . | should do this . . . | does this . . . | should do this . . . |
| Defaults | Standard | Defaults | unlisted |
| Ring | Play SheRingTone, | Ring | Standard |
| | Display ShePicture.jpg | | |
| Connect | Play SheFavoriteSong | Connect | Standard |
| Hold | Play ElevatorMusic | Hold | Standard |
| Disconnect | Play ByeByeRingTone | Disconnect | Standard |

### Edit Friends Secretary View

This Edit Friends screen instructs His Secretary what to do when each of the above two individuals calls He. In particular, if She calls, He wants to hear her special ring tone and see her picture flashed on His Secretary's console. If She connects, He wants her to hear her favorite song playing over his speakers in the background. If She puts him on hold, He wants to be able to identify her call by the music playing out of his speaker. If She disconnects, He wants to know it. In one embodiment, the call features are implemented using Java Telephony application program interface (JTAPI) to support telephony call control. JTAPI is an extensible API designed to scale for use in a range of domains, from first-party call control in a consumer device to third-party call control in large distributed call centers.

By contrast, He is quite happy to have his friend RiceBud interact with him in the standard way, except that he wants his connection information to be unlisted to RiceBud. There are many other possible conditions to which the user can apply preferences, including all calls, no answer, busy, after hours, and extended absence. Upon exiting the Edit Friends screen, the server 310 downloads the appropriate ring tones, JPG images, and actions to His secretary using standard methods known in the art.

After the My Friends entry modification step described above, He and She continue to be able to see each other in their My Friends views. However, as distinguished from the gallery, the My Friends view has icons adjacent to some of the names; these icons indicate call availability status. For example, a green [symbol] means that the friend is on-line and available for a call. A yellow [symbol] means that the friend is on-line but unavailable for a call. A green [symbol] [symbol] means that the friend is on-line in a conference call that is still accepting friends. A yellow [symbol] [symbol] means that the friend is on-line in a conference call that is not accepting any more friends. In one embodiment, all entries with icons are available for communication via connect. When connected, green entries are called, yellow entries are Instant Messaged. Entries with no icon are either offline and unavailable for connection or unlisted. An example of the My Friends view is shown below.

| | | | | |
|---|---|---|---|---|
| She [symbol] | RiceBud [symbol] | Laurie | Gil [symbol] [symbol] | Sira [symbol] [symbol] |
| connect | <picture> | <picture> | connect | connect |
| <picture> | | | <picture> | <picture> |

### My Friends View

To place a call, She goes to the My Friends view, selects He's picture, (which is in the green [symbol] state) and presses the “connect” link. The server 310 updates its state to reflect that He and She are in yellow [symbol] state; and invokes the VOIP connection process as described above. Upon receiving the incoming call, He's secretary executes the ring actions He has specified. Upon call completion, an event is sent to the server 310.

Several additional options are available using the above example. One example is queued call waiting, which is an extension of a message waiting indication in a voice system. Others are platforms including notification and voicemail.

Using a platform with notification, if He receives no call from She during a certain timeframe, e.g., from the point he updated She's entry until Wednesday, he will receive a reminder to call her. An example of the My Friends screen for this reminder is shown below.

| She [Delete Friend] | | RiceBud [Delete Friend] | |
|---|---|---|---|
| <picture> | | <picture> | |
| If the | | If the | |
| Phone | Then your Secretary | Phone | Then your Secretary |
| does this . . . | should do this . . . | does this . . . | should do this . . . |
| Defaults | Remind me Call | Defaults | Standard |
| | Wednesday | | |
| Ring | Standard | Ring | Standard |
| Connect | Standard | Connect | Standard |
| Hold | Standard | Hold | Standard |
| Disconnect | Standard | Disconnect | Standard |

### My Friends View (with Reminder)

Using a platform with voicemail, if He misses She's call, He wants She to hear a special voicemail message. In addition, He wants his secretary to page him. In one embodiment, this platform is implemented as a paid service, and the call is rerouted to the server on a voicemail event. In another embodiment, the message is recorded on the originator machine and emailed to the destination. Voicemail can be stored either on the server 310 or emailed to the destination. An example of the My Friends view with voicemail and page me for She is shown below.

| She [Delete Friend] | | RiceBud [Delete Friend] | |
|---|---|---|---|
| <picture> | | <picture> | |
| If the | | If the | Then your |
| Phone does | Then your Secretary | Phone | Secretary |
| this . . . | should do this . . . | does this . . . | should do this . . . |
| Defaults | Standard | Defaults | Standard |
| Ring | Standard | Ring | Standard |
| Voicemail | Play SheVoiceMailMsg, | Voicemail | Standard |
| | Page Me! | | |
| Connect | Standard | Connect | Standard |
| Hold | Standard | Hold | Standard |
| Disconnect | Standard | Disconnect | Standard |

### My Friends View (Voicemail and Page Me)

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may include a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for disclosure of enablement and best mode of the present invention.

The present invention is well suited to a wide variety of computer network systems over numerous topologies. Within this field, the configuration and management of large networks include storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

1. A method for unifying online communities, comprising:
establishing a universal identity for a user;
ascertaining an identity for the user in each of at least two online communities;
creating a table associated with the user;
cross-referencing in the table the universal identity with the identity for the user in each of the at least two online communities;
ascertaining an identity of at least one member linked with the user in at least one of the at least two online communities; and
adding the identity of the at least one member to the table.

2. The method of claim 1, wherein the table associated with the user includes additional information about the user.

3. The method of claim 1, wherein the at least one member is a single member with a first member identity in a first of the at least two online communities and a second member identity in a second of the at least two online communities.

4. The method of claim 3, wherein adding the identity adds the first member identity and the second member identity to the table.

5. The method of claim 4, further comprising cross-referencing the first member identity and the second member identity.

6. The method of claim 1, wherein ascertaining an identity of at least one member comprises importing identity information about the at least one member as entered by the user from the at least one of the at least two online communities upon permission from the user.

7. The method of claim 6, wherein the importing takes place without user interaction.

8. The method of claim 6, wherein the importing is performed according to preferences specified by the user.

9. The method of claim 6, further comprising, prior to importing identity information, receiving from the user an indication as to how much of the identity information is shared with members in the at least two online communities.

10. The method of claim 1, further comprising ascertaining available modes of communication for the at least one member.

11. The method of claim 1, further comprising:
importing from each of the at least two online communities information entered by the user;
integrating the information in the table associated with the user; and
making the information available to the at least one member upon permission from the user.

12. The method of claim 1, further comprising:
importing from the email client information entered by the user.

13. The method of claim 11, wherein the importing takes place without user interaction.

14. The method of claim 11, wherein the information allows deduction of a network of members of the at least two online communities, including degrees by which members of the network are separated.

15. A method of initiating communication in a second mode between an originator and a recipient linked to one another in a first mode, comprising:
receiving a command from the originator to initiate communication with the recipient in the second mode, wherein the command does not include an identity for the recipient in the second mode;
determining the identity for the recipient in the second mode; and
initiating communication in the second mode using the identity for the recipient.

16. The method of claim 15, further comprising displaying a user interface for receiving the command and initiating communication in the second mode.

17. The method of claim 15, wherein receiving a command comprises receiving a selection of the recipient from an address book in the first mode.

18. The method of claim 15, wherein receiving a command comprises detecting a right-click on a picture of the recipient in the first mode.

19. The method of claim 18, wherein right-clicking displays a list of communication mode options.

20. The method of claim 15, wherein determining the identity for the recipient comprises searching among a plurality of networks for the identity for the recipient in the second mode.

21. The method of claim 20, further comprising in response to finding the identity of the recipient in the second mode in one of the plurality of networks, importing recipient identity information as entered by the originator from the one of the plurality of networks upon permission of the originator.

22. The method of claim 20, wherein the importing takes place without user interaction.

23. The method of claim 21, further comprising, prior to importing identity information, receiving from the user an indication as to how much of the identity information is shared with members in the plurality of networks.

24. The method of claim 15, wherein the command does not specify which of available modes is the second mode.

25. The method of claim 15, wherein the second mode provides an additional capability beyond communication.

26. The method of claim 15, wherein the first mode comprises an online social network and the second mode comprises internet telephony.

27. A method of invoking services in a second social network between an originator and a recipient linked to one another in a first social network, comprising:
receiving a command from the originator to invoke a second social network service with the recipient, wherein the command does not include an identity for the recipient in the second mode;
determining the identity for the recipient in the second mode; and
invoking the second social network service using the identity for the recipient.

28. The method of claim 27, wherein the first social network and second social network are not in communication with each other.

29. The method of claim 27, further comprising displaying a user interface for receiving the command and invoking the second social network service.

30. A computer program product for unifying online communities, comprising:
a computer-readable medium; and
computer program code, coded on the medium, for:
establishing a universal identity for a user;
ascertaining an identity for the user in each of at least two online communities;
creating a table associated with the user;
cross-referencing in the table the universal identity with the identity for the user in each of the at least two online communities;
ascertaining an identity of at least one member linked with the user in at least one of the at least two online communities; and
adding the identity of the at least one member to the table.

31. The computer program product of claim 30, wherein the table associated with the user includes additional information about the user.

32. The computer program product of claim 30, wherein the at least one member is a single member with a first member identity in a first of the at least two online communities and a second member identity in a second of the at least two online communities.

33. The computer program product of claim 32, wherein adding the identity adds the first member identity and the second member identity to the table.

34. The computer program product of claim 31, further comprising computer program code, coded on the medium, for cross-referencing the first member identity and the second member identity.

35. The computer program product of claim 30, wherein ascertaining an identity of at least one member comprises importing identity information about the at least one member as entered by the user from the at least one of the at least two online communities upon permission from the user.

36. The computer program product of claim 35, wherein the importing takes place without user interaction.

37. The computer program product of claim 35, wherein the importing is according to preferences specified by the user.

38. The computer program product of claim 35, further comprising computer program code, coded on the medium, for receiving from the user an indication as to how much of the identity information is shared with members in the at least two online communities.

39. The computer program product of claim 30, further comprising computer program code, coded on the medium, for ascertaining available modes of communication for the at least one member.

40. A computer program product for initiating communication in a second mode between an originator and a recipient linked to one another in a first mode, comprising:
a computer-readable medium; and
computer program code, coded on the medium, for:
receiving a command from the originator to initiate communication with the recipient in the second mode, wherein the command does not include an identity for the recipient in the second mode;
determining the identity for the recipient in the second mode; and
initiating communication in the second mode using the identity for the recipient.

41. The computer program product of claim 40, further comprising displaying a user interface for receiving the command and initiating communication in the second mode.

42. The computer program product of claim 40, wherein receiving a command comprises receiving a selection of the recipient from an address book in the first mode.

43. The computer program product of claim 40, wherein receiving a command comprises detecting a right-click on a picture of the recipient in the first mode.

44. The computer program product of claim 43, wherein right-clicking displays a list of communication mode options.

45. The computer program product of claim 40, wherein determining the identity for the recipient comprises searching among a plurality of networks for the identity for the recipient in the second mode.

46. The computer program product of claim 45, further comprising computer program code, coded on the medium, for:
importing recipient identity information from the one of the plurality of networks as entered by the originator in response to finding the identity of the recipient in the second mode in one of the plurality of networks and receiving permission from the originator.

47. The computer program product of claim 46, further comprising computer program code, coded on the medium, for receiving from the user an indication as to how much of the identity information is shared with members in the plurality of networks.

48. The computer program product of claim 40, wherein the command does not specify which of available modes is the second mode.

49. The computer program product of claim 40, wherein the second mode provides an additional capability beyond communication.

50. A computer program product for invoking services in a second social network between an originator and a recipient linked to one another in a first social network, comprising:
a computer-readable medium; and
computer program code, coded on the medium, for:
receiving a command from the originator to invoke a second social network service with the recipient, wherein the command does not include an identity for the recipient in the second mode;
determining the identity for the recipient in the second mode; and
invoking the second social network service using the identity for the recipient.

51. A system for unifying online communities, comprising:
a software portion for establishing a universal identity for a user;
a software portion for ascertaining an identity for the user in each of at least two online communities;
a software portion for creating a table associated with the user and cross-referencing in the table the universal identity with the identity for the user in each of the at least two online communities;
a software portion for ascertaining an identity of at least one member linked with the user in at least one of the at least two online communities; and
wherein the software portion for creating a table is configured for adding the identity of the at least one member to the table.

52. The system of claim 51, wherein the table associated with the user includes additional information about the user.

53. The system of claim 51, wherein the at least one member is a single member with a first member identity in a first of the at least two online communities and a second member identity in a second of the at least two online communities.

54. The system of claim 53, wherein adding the identity adds the first member identity and the second member identity to the table.

55. The system of claim 51, wherein the software portion for creating a table is further configured for cross-referencing the first member identity and the second member identity.

56. The system of claim 51, wherein ascertaining an identity of at least one member comprises importing identity information about the at least one member as entered by the user from the at least one of the at least two online communities upon permission from the user.

57. The system of claim 56, wherein the importing takes place without user interaction.

58. The system of claim 56, wherein the importing is according to preferences specified by the user.

59. The system of claim 56, wherein the software portion for ascertaining an identity of at least one member receives an indication as to how much of the identity information is shared with members in the at least two online communities.

60. The system of claim 51, further comprising a software portion for ascertaining available modes of communication for the at least one member.

61. A system for initiating communication in a second mode between an originator and a recipient linked to one another in a first mode, comprising:
a software portion for receiving a command from the originator to initiate communication with the recipient in the second mode, wherein the command does not include an identity for the recipient in the second mode;
a software portion for determining the identity for the recipient in the second mode; and
a software portion for initiating communication in the second mode using the identity for the recipient.

62. The system of claim 61, further comprising a software portion for displaying a user interface for receiving the command and initiating communication in the second mode.

63. The system of claim 61, wherein receiving a command comprises receiving a selection of the recipient from an address book in the first mode.

64. The system of claim 61, wherein receiving a command comprises detecting a right-click on a picture of the recipient in the first mode.

65. The system of claim 64, wherein right-clicking displays a list of communication mode options.

66. The system of claim 61, wherein the software portion for determining the identity for the recipient is configured for searching among a plurality of networks for the identity for the recipient in the second mode.

67. The system of claim 66, further comprising a software portion for importing recipient identity information from the one of the plurality of networks as entered by the originator in response to finding the identity of the recipient in the second mode in one of the plurality of networks and receiving permission from the originator.

68. The system of claim 67, wherein software portion for ascertaining an identity of at least one member receives an indication as to how much of the identity information is shared with members in the plurality of networks.

69. The system of claim 61, wherein the command does not specify which of available modes is the second mode.

70. The system of claim 61, wherein the second mode provides an additional capability beyond communication.

71. A system for of invoking services in a second social network between an originator and a recipient linked to one another in a first social network, comprising:
a software portion for receiving a command from the originator to invoke a second social network service with the recipient, wherein the command does not include an identity for the recipient in the second mode;
a software portion for determining the identity for the recipient in the second mode; and
a software portion for invoking the second social network service using the identity for the recipient.

72. A computer readable memory storing a computer program executable by a processor, the computer program producing a user interface for initiating communication in a second mode between an originator and a recipient linked to one another in a first mode, the user interface comprising:
a first area for displaying a directory of friends of the originator, the directory including the recipient; and
an executable process that responds to receiving a command from the originator to initiate communication with the recipient in the second mode, wherein the command does not include an identity for the recipient in the second mode.

73. The computer readable memory of claim 72, wherein the user interface further comprises:
a second area for displaying preferences associated with each of the friends of the originator; and
an executable process that responds to receiving an incoming call from one of the friends to execute the preferences.

74. The computer readable memory of claim 73, wherein the preferences include personalized ringtones.

75. The computer readable memory of claim 73, wherein the preferences include personalized animation.

76. The computer readable memory of claim 72, wherein the first area displays call availability status for the friends of the originator in the directory.
